(19) United States
(12) Patent Application Publication
(10) Pub. No.: US 2022/0416263 A1
(43) Pub. Date: Dec. 29, 2022

(54) HEAT AND CHEMICAL RESISTANT SEALANTS FOR FUEL CELLS

(71) Applicant: UltraCell LLC, Livermore, CA (US)

(72) Inventors: Ru CHEN, Dublin, CA (US); Ian W. KAYE, Livermore, CA (US); John Ryan MURPHY, Tracy, CA (US); Stephen ROCK, Gansevoort, NY (US)

(21) Appl. No.: 17/849,348

(22) Filed: Jun. 24, 2022

Related U.S. Application Data
(60) Provisional application No. 63/215,326, filed on Jun. 25, 2021.

(51) Int. Cl. H01M 8/0284; H01M 8/0286

(52) U.S. Cl. CPC H01M 8/0284; H01M 8/0286

(57) ABSTRACT

A heat and chemical resistant sealant for fuel cells that includes a fluoroelastomer sealant and a fluoroplastic gasket. The fluoroelastomer sealant is dispensed around a perimeter of a top surface of a bipolar plate. The compliant sealant conforms to surface imperfections of the bipolar plate. A fluoroplastic gasket is positioned over the fluoroelastomer sealant and bipolar plate. When compressed, the combination of the fluoroelastomer sealant and fluoroplastic gasket provide a reliable seal that can withstand the high operating temperatures of fuel cells.

### RELATED APPLICATIONS

This application claims the benefit of U.S. Provisional Application No. 63/215,326, filed on Jun. 25, 2021. The foregoing application is hereby incorporated by reference herein for all purposes.

### BACKGROUND OF THE INVENTION

The present disclosure generally relates to fuel cells. More specifically, the disclosure relates to sealing fuel cell systems.

Fuel cells are electrochemical devices that can be used in a wide range of applications, including transportation, material handling, stationary, and portable power applications. Fuel cells use fuel and air to generate electricity by electrochemical reactions and release reaction products as exhaust. In fuel cells, membrane electrode assemblies (MEAs) are sandwiched between two bipolar plates. In high temperature polymer electrolyte membrane (PEM) fuel cells, high temperature plastic films are typically used as gaskets in fuel cell stacks. The gaskets are rigid, and they do not easily conform to rough surfaces of bipolar plates. The two mating surfaces cannot form a reliable seal between bipolar plates and MEAs. Liquid silicone rubbers have been proposed for molding onto MEAs as well as onto porous bipolar plates. A fluoroelastomer sealant applied externally of MEAs and bipolar plates has also been suggested and perfluoropolyether greases have also been applied on gaskets to improve sealing, but the grease evaporates gradually at elevated temperatures.

Thus, it has been challenging to form an adequate seal between bipolar plates and MEAs. Therefore, it would be desirable to be able to provide a reliable seal between bipolar plates and MEAs that will last.

### SUMMARY OF THE INVENTION

In accordance with an embodiment, a method is provided for sealing a fuel cell assembly. A bipolar plate is provided. A fluoroelastomer sealant is applied around a perimeter of a top surface of the bipolar plate. A fluoroplastic gasket is then positioned over the fluoroelastomer sealant and the bipolar plate.

In accordance with another embodiment, a fuel cell assembly is provided. The fuel cell assembly include a bipolar plate, a membrane electrode assembly; and a seal between the bipolar plate and the membrane electrode assembly, the seal comprising a fluoroelastomer sealant and a fluoroplastic gasket over the fluoroelastomer sealant.

### BRIEF DESCRIPTION OF THE DRAWINGS

The invention, together with further objects and advantages thereof, may best be understood by reference to the following description taken in conjunction with the accompanying drawings in which:

FIG. 1A is a top view of a bipolar plate in accordance with an embodiment.

FIG. 1B shows a fluoroelastomer sealant applied around the perimeter of the bipolar plate shown in FIG. 1A.

FIG. 1C shows a fluoroplastic gasket positioned over the fluoroelastomer sealant on the bipolar plate shown in FIGS. 1A and 1B.

FIG. 1D is a side view of a bipolar plate having a fluoroelastomer sealant and gasket on both surfaces of the bipolar plate in accordance with an embodiment.

FIG. 2 shows different dispensing strategies for the fluoroelastomer sealant.

FIG. 3 shows an example of a X-Y parallel flexural linkage.

FIG. 4 is a flow chart of a method of sealing a fuel cell assembly in accordance with an embodiment.

### DETAILED DESCRIPTION OF EMBODIMENTS

The present invention relates generally to fuel cell systems. Portable fuel cell systems can be placed in a backpack and worn by users to provide power to various electronic devices, such as radio and satellite communications gear, laptop computers, night vision goggles, and remote surveillance systems. Embodiments of fuel cell systems described herein can continue generate and provide power in remote locations at extreme temperatures. The fuel cell systems described herein are fueled by hydrogen-rich gases produced by reforming methanol. It will be understood that, in other embodiments, a fuel cell system can be fueled by other fuels, such as hydrogen.

According to embodiments described herein, the fuel cells can be PEM fuel cells having a MEA. In a PEM fuel cell fueled by hydrogen, the membrane allows protons to transfer from an anode to a cathode with catalysts on both electrodes to assist in chemical reactions. Hydrogen is provided to the anode while oxygen is provided to the cathode. The hydrogen breaks down at the anode into electrons and protons, and the electrons pass through an external electrical circuit connected to the fuel cell to provide electrical power while the protons pass through the membrane to the cathode. The electrons and protons combine with oxygen at the cathode to produce water vapor.

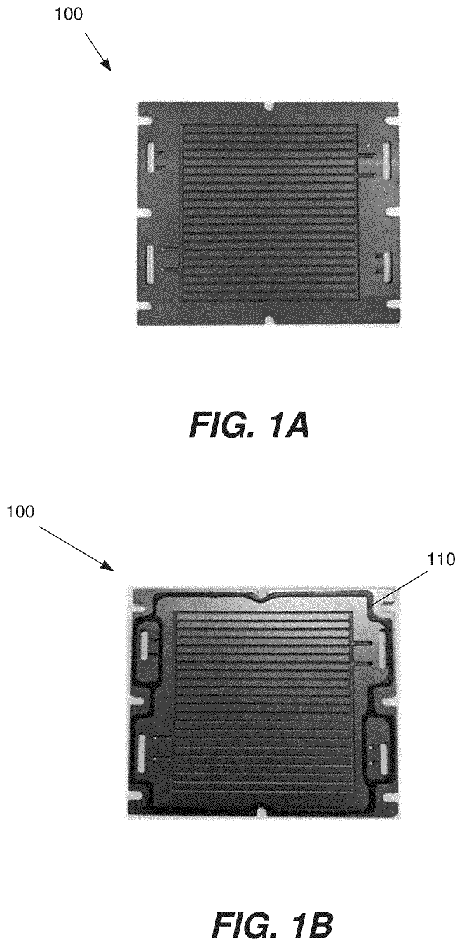

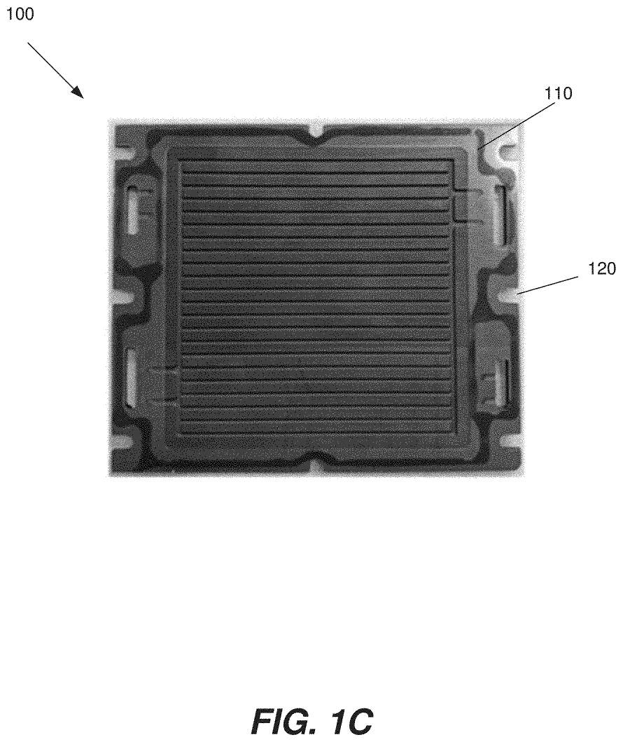

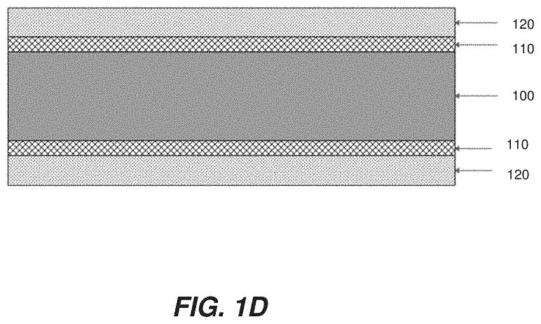

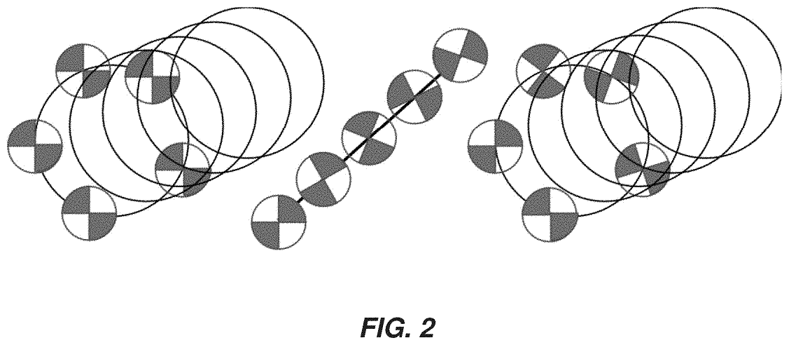

FIG. 1A is a top view of a bipolar plate 100. Bipolar plates are positioned between individual fuel cells to separate them and provide electrical connection between the cells. The bipolar plates also provide physical structure and allow the stacking of individual fuel cells into fuel cell stacks to provide higher voltages. In some embodiments, the fuel cell system is fueled by hydrogen-rich gases produced by reforming methanol, natural gas, or liquefied petroleum gas, etc. In other embodiments, the fuel cell system can be fueled by other fuels, such as hydrogen. It will be understood that any other types of fuel cells can be used in a fuel cell system, including solid acid fuel cells, solid oxide fuel cells, phosphoric acid fuel cells, molten carbonate fuel cells, and alkaline fuel cells.

According to an embodiment, to seal reactant passages between MEAs and bipolar plates 100, a fluoroplastic gasket and a fluoroelastomer sealant are combined as the sealing material. Suitable fluoroelastomers include FKM, FFKM, and FEPM. All FKMs contain vinylidene fluoride as a monomer. FKMs can be divided into different types based on their chemical compositions. They are produced by many companies, including DuPont/Chemours (Viton®), Daikin (Dai-EL), 3M (Dyneon), Solvay S.A. (Tecnoflon), HaloPolymer (Elaftor), Gujarat Fluorochemicals (Fluonox), and Zrunek (ZruElast). FFKMs are perfluoroelastomers containing an even higher amount of fluorine than FKMs. FEPM is tetrafluoroethylene propylene-based elastomers. They offer a combination of high temperature and chemical resistance. The fluoroelastomers can be cross-linked using different mechanisms: diamine, bisphenol, and peroxide cross-linking. The fluoroelastomer is mixed with a cross-linker, a solvent, and other ingredients. The fluoroelastomer mixture 110 is applied on a top surface of the bipolar plate using a fluid dispensing system.

FIG. 1B shows the fluoroelastomer mixture 110 as dispensed around the perimeter of the top surface a bipolar plate 100. The fluoroplastic gasket 120 is placed on top of the fluoroelastomer layer 110, as shown in FIG. 1C. In the top view of FIG. 1C, the fluoroelastomer layer 110 can be seen through the transparent gasket 120. The fluoroelastomer 110 can be cured in approximately 24-48 hours at room temperature. The curing time can be reduced to 20 minutes at 150° C. After it is assembled and compressed in fuel cell stacks, the resilient fluoroelastomer layer 110 reliably seals the reactant passages between the gaskets 120 and the bipolar plates 100 and prevents overboard and cross-over leaks. According to an embodiment, after application of the fluoroelastomer layer 110 and the gasket 120, the assembly is compressed by applying force of about 100 psi.

The fluoroplastic gasket 120 works as a hard stop and prevents over-compression of the MEAs. The gasket 120 has a high compression modulus, which reduces the stress relaxation and creep. The gasket materials can be perfluoroalkoxy alkane (PFA), reinforced polytetrafluoroethylene (PTFE), and polyphenylsulfones, such as Radel® PPSU. The fluoroelastomer layer 110 is compliant and conforms to the imperfect surfaces of bipolar plates 100. The sealing material is chemically stable at the high temperatures, high acidic, and oxidative environment of high temperature PEM fuel cells up to a temperature of about 240° C. According to an embodiment, the fluoroelastomer sealant is configured to withstand temperatures up to about 330° C.

The fluoroelastomer sealants 110 described herein form a good seal between the graphite material of the bipolar plate 100, which typically has a surface roughness, and the smooth PFA gasket 120 which serves both to promote a seal with the MEA gasket material as well as serve as a hard stop pocket. The bipolar plate materials can be graphite/polymer composites, resin-impregnated graphite, and metals. According to an embodiment, the bipolar plate 100 has a surface roughness Rₐ of 1-2 μm and the gasket 120 has a surface roughness Rₐ of about 0.05-0.1 μm. Thus, it is believed the smearing action of dragging the dispensing tip in close proximity to the bipolar plate 100 may enhance the contact between the fluoroelastomer sealant 110 and the rough surface of the bipolar plate 100 and promote a better sealing. It may be possible to enhance this action by orbiting and/or spinning the deposition tip during dispensing to introduce additional shearing between the fluoroelastomer sealant material 110 and the bipolar plate substrate 110.

It will be appreciated that the fluoroelastomer sealant 110 and gasket 120 can be applied to both sides of the bipolar plate. FIG. 1D shows a bipolar plate 100 having a fluoroelastomer sealant 110 and gasket 120 on both surfaces of the bipolar plate 100 in accordance with an embodiment.

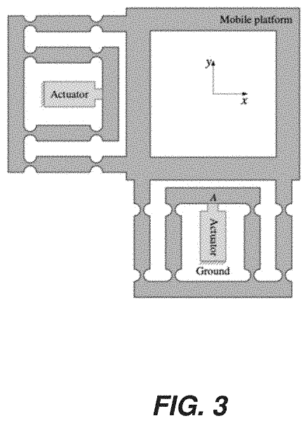

Different fluoroelastomer sealant 110 dispensing strategies are shown in FIG. 2. On the left side of FIG. 2, an orbital dispensing strategy is shown. In the middle of FIG. 2, a tip rotation strategy is shown, and a combined orbital and tip rotation dispensing strategy is shown on the right side of FIG. 2. It will be noted that an added benefit of provisioning for orbital travel of the dispensing tip is that it may be possible to modulate the width of the dispensed fluid by carefully controlling the orbit amplitude. It should be appreciated that many other trajectories may achieve similar benefits, such as following a zigzag or sinusoidal oscillation oriented either in the travel direction or transverse to it. It is possible that they could lead to beneficial material build up depending on the plate geometry and proximity to surface features on the bipolar plate 100.

While traditional computer-controlled motion systems used in dispensing, such as cartesian gantries and various robot architectures (SCARA, 6DOF, etc.) may be commanded to generate orbital and rotational motions at the tip, it is believed that the acceleration demands of this application may be detrimental to the motion system lifetime and reflect unacceptably high levels of vibration back into the balance of system and parts being handled. If orbital and/or rotation tip motion is to be applied, it is likely best accomplished by manipulating only the dispensing tip or as low a mass of dispensing hardware as practical rather than engaging the full robot arm or discrete cartesian motion axes in this endeavor. This might be accomplished using a combination of parallel flexural linkages. FIG. 3 shows an example of a X-Y parallel flexural linkage.

It will be noted that orbital motion might also be equally well achieved by supporting the dispensing tip from a spring mount and then applying an eccentric mass, such as that found in a cell phone vibration motor, to cause the orbital motion of the tip. However, this would likely suffer from unintended responses caused by robot motion (assuming a movable dispense nozzle vs. a stationary configuration). A tapered tip geometry may be useful in combination with the orbiting concept as any lateral motion would lead to an additional downward force of the material toward the bipolar plate 100. It is also possible to modulate the flow of the sealant 110 in proportion to the robot/motion system path velocity to deposit a consistent quantity of sealant 110 and minimize waste.

A variety of processes can be used to apply the fluoroelastomer layer 110 on bipolar plates 100, including, for example, dispensing, 3D printing, screen printing, inkjet printing, pad printing, brushing, and spraying. However, the properties of the fluoroelastomer mixture 110 can change because of evaporation of the solvent. The solvent evaporation can be minimized if the fluoroelastomer mixture 110 is not exposed to the environment before dispensing.

Dispensing the fluoroelastomer sealant 110 on bipolar plate 100 can be accomplished by using a variety of different methods, including manual dispensing as well as the use of dispensing machines, including a screw driven syringe dispenser available from Fishman Corporation of Hopkinton, Mass. and a Delta 8 dispenser available from PVA of Halfmoon, N.Y. A variety of dispensing tips and needles are available for dispensers. For example, DL Technologies of Haverhill, Mass. manufactures a variety of dispensing tips and needles for such dispensers.

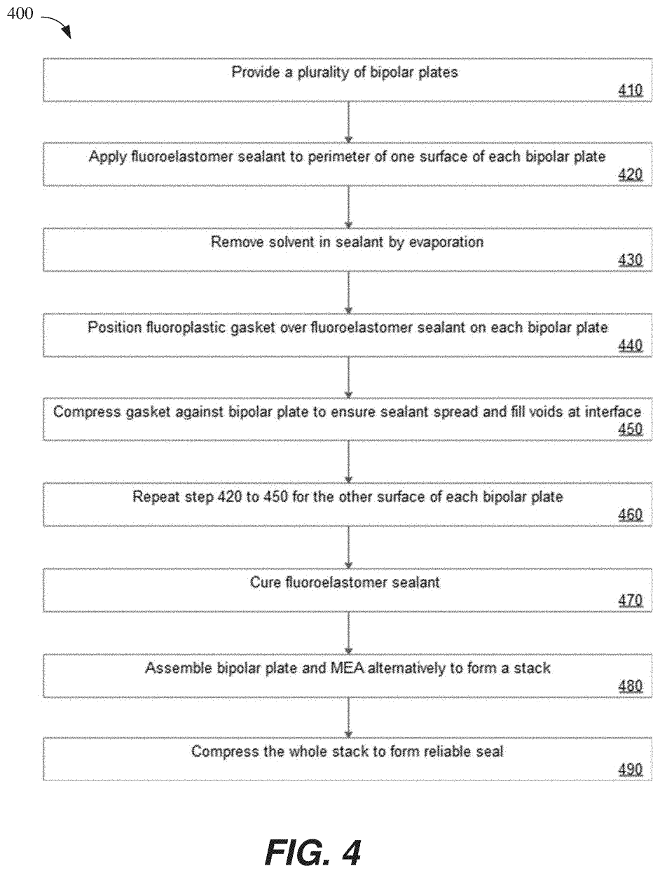

FIG. 4 a flow chart of a method 400 of sealing a fuel cell assembly in accordance with an embodiment. In Step 410, a plurality of bipolar plates 100 is provided. In a particular embodiment, the bipolar plates are formed of graphite and have surface roughness. In Step 420, a fluoroelastomer sealant 110 is applied on one surface of each of the bipolar plates 100 around the perimeter. The solvent in the sealant is removed by evaporation in Step 430. A fluoroplastic gasket 120 is then positioned over the fluoroelastomer sealant 110 on each of the bipolar plates 100 in Step 440. The gasket 120 is pressed against the bipolar plate to ensure the compliant sealant spreads and fills in the voids or imperfections between the mating surfaces in Step 450. The process from Step 420 to 450 can be repeated for the other surface of each bipolar plate. Each bipolar plate has two gaskets attached to both surfaces after Step 460. The fluoroelastomer sealant is cured at room temperature or elevated temperatures in Step 470. Bipolar plates and MEAs are assembled alternatively to form a fuel cell stack in Step 480. The whole stack is compressed to form reliable seals in the stack in Step 490.

In view of the foregoing, it should be apparent that the present embodiments are illustrative and not restrictive and the invention is not limited to the details given herein but may be modified within the scope and equivalents of the appended claims.

What is claimed is:

1. A method of sealing a fuel cell assembly, the method comprising:
providing a bipolar plate;
applying a fluoroelastomer sealant around a perimeter of a top surface of the bipolar plate; and
positioning a fluoroplastic gasket over the fluoroelastomer sealant and the bipolar plate.

2. The method as recited in claim 1, further comprising curing the fluoroelastomer sealant at a temperature of about 150° C. in about 20 minutes.

3. The method as recited in claim 1, wherein the bipolar plate has a surface roughness of about 1-2 μm.

4. The method as recited in claim 3, wherein the fluoroelastomer sealant is compliant and conforms to surface imperfections of the bipolar plate after the fluoroelastomer sealant is applied to the bipolar plate.

5. The method as recited in claim 1, wherein the fluoroelastomer sealant is dispensed onto the top surface of the bipolar plate.

6. The method as recited in claim 1, wherein the fluoroelastomer sealant is printed onto the top surface of the bipolar plate.

7. The method as recited in claim 1, further comprising applying force of about 100 psi to compress the fluoroelastomer sealant after positioning the fluoroplastic gasket over the fluoroelastomer sealant and the bipolar plate.

8. The method as recited in claim 1, further comprising mixing a fluoroelastomer with a cross-linker and a solvent to form the fluoroelastomer sealant before applying the fluoroelastomer sealant.

9. The method as recited in claim 1, wherein the fluoroelastomer sealant is applied to the bipolar plate by a method selected from the group consisting of: dispensing, 3D printing, screen printing, inkjet printing, pad printing, brushing, or spraying.

10. The method as recited in claim 1, wherein the fuel cell assembly is configured to operate at temperatures of about 240° C.

11. The method as recited in claim 1, wherein the fluoroelastomer sealant is configured to withstand temperatures up to about 330° C. without degrading.

12. A fuel cell assembly, comprising:
a bipolar plate;
a membrane electrode assembly; and
a seal between the bipolar plate and the membrane electrode assembly, the seal comprising:
a fluoroelastomer sealant; and
a fluoroplastic gasket over the fluoroelastomer sealant.

13. The fuel cell assembly as recited in claim 12, wherein the fluoroelastomer sealant is dispensed around a perimeter of the bipolar plate.

14. The fuel cell assembly as recited in claim 12, wherein the fluoroelastomer sealant is printed around a perimeter of the bipolar plate.

15. The fuel cell assembly as recited in claim 12, wherein the bipolar plate has a surface roughness of about 1-2 μm.

16. The fuel cell assembly as recited in claim 12, wherein the fluoroelastomer sealant is compliant and conforms to surface imperfections of the bipolar plate.

17. The fuel cell assembly as recited in claim 12, wherein the fluoroelastomer sealant comprises a mixture of a fluoroelastomer with a cross-linker and a solvent.

18. The fuel cell assembly as recited in claim 12, wherein the fuel cell assembly is configured to operate at temperatures of about 240° C.

19. The fuel cell assembly as recited in claim 12, wherein the fluoroelastomer sealant is configured to withstand temperatures up to about 330° C. without degrading.

20. The fuel cell assembly as recited in claim 12, wherein the fluoroplastic gasket has a surface roughness of about 0.05-0.1 μm.
